(19) United States
(12) Patent Application Publication
(10) Pub. No.: US 2024/0421321 A1
(43) Pub. Date: Dec. 19, 2024

(54) ELECTRODE FOR LITHIUM SECONDARY BATTERY WITH CONTROLLED SURFACE ROUGHNESS

(71) Applicants: HYUNDAI MOTOR COMPANY, Seoul (KR); KIA CORPORATION, Seoul (KR)

(72) Inventors: Yong Guk Gwon, Suwon-si (KR); Min Su Kim, Goyang-si (KR); Yong Seok Choi, Suwon-si (KR); Young Jin Nam, Seoul (KR)

(73) Assignees: HYUNDAI MOTOR COMPANY, Seoul (KR); KIA CORPORATION, Seoul (KR)

(21) Appl. No.: 18/521,555

(22) Filed: Nov. 28, 2023

(30) Foreign Application Priority Data
Jun. 16, 2023 (KR) 10-2023-0077151

(51) Int. Cl. H01M 4/70; H01M 10/052

(52) U.S. Cl. CPC H01M 4/70; H01M 10/052; H01M 50/105

(57) ABSTRACT

The present disclosure relates to a dry electrode for a lithium secondary battery with controlled surface roughness and a pouch-type lithium secondary battery including the same.

### CROSS-REFERENCE TO RELATED APPLICATION

The present application claims priority to Korean Patent Application No. 10-2023-0077151 filed on Jun. 16, 2023, the entire contents of which is incorporated herein for all purposes by this reference.

### BACKGROUND OF THE PRESENT DISCLOSURE

### Field of the Present Disclosure

The present disclosure relates to a dry electrode for a lithium secondary battery with controlled surface roughness and a pouch-type lithium secondary battery including the same.

### Description of Related Art

When an electrode for a lithium secondary battery is manufactured by a dry method, a surface of the electrode may have unevenness or irregularities due to reasons such as insufficient shear stress applied to the electrode.

When the lithium secondary battery is a pressed cell, there is no problem in operation because an effect of the uneven surface is small. However, when the lithium secondary battery is a pouch cell, the cell may not operate normally because an effect of the surface roughness is great.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a dry electrode for a lithium secondary battery including a uniform thickness.

The present disclosure is directed to providing a dry electrode for a lithium secondary battery in which various factors such as a width, an interval, and the like of patterns formed during film formation are controlled.

The object of the present disclosure is not limited to the above-described. The objects of the present disclosure will become more apparent from the following description, and will be realized by means and combinations thereof described in the claims.

An electrode for a lithium secondary battery according to an exemplary embodiment of the present disclosure has a sheet shape including a first main surface and a second main surface facing the first main surface.

A thickness (A) at any one point on the first main surface and an average thickness (B) of the thickness (A) at the any one point on the first main surface satisfy Expression 1 below.

$$\vert A - B \vert \leq 0.1 \cdot B . \qquad [ Expression 1 ]$$

The electrode for the lithium secondary battery may include a flat part, and a plurality of pattern parts protruding with a predetermined width in a width direction of the electrode, wherein the plurality of pattern parts may be spaced apart from each other at a predetermined distance.

The electrode may satisfy Expression 2 below.

$$C < 0.6 \cdot D \qquad [ Expression 2 ]$$

In Expression 2, C may be the shortest distance between any one pattern part and another pattern part adjacent thereto, and D may be a distance between a center line of any one pattern part and a center line of another pattern part adjacent thereto based on a center portion of the width of the electrode.

The electrode may satisfy Expression 3 below.

$$1.3 \cdot D < E \qquad [ Expression 3 ]$$

In Expression 3, D may be a distance between a center line of any one pattern part and a center line of another pattern part adjacent thereto based on a center portion of the width of the electrode, and E may be the longest distance between any one pattern part and another pattern part adjacent thereto.

A distance between a center line of any one pattern part and a center line of another pattern part adjacent thereto may be about 150 μm or less.

The electrode may satisfy Expression 4 below.

$$3 \leq F / G \qquad [ Expression 4 ]$$

In Expression 4, F may be an area of the flat part, and G may be an area of the pattern part.

A pouch-type lithium secondary battery according to an exemplary embodiment of the present disclosure includes an electrode assembly, and a case configured to store the electrode assembly, wherein the electrode assembly includes the electrode.

According to an exemplary embodiment of the present disclosure, it is possible to obtain the dry electrode for the lithium secondary battery including the uniform thickness.

According to an exemplary embodiment of the present disclosure, it is possible to obtain the dry electrode for the lithium secondary battery in which various factors such as a width, an interval, and the like of the patterns formed during film formation are controlled.

According to an exemplary embodiment of the present disclosure, it is possible to obtain the pouch-type lithium secondary battery having predetermined interfacial resistance, excellent electronic conductivity, and lithium ion conductivity.

According to an exemplary embodiment of the present disclosure, it is possible to obtain the pouch-type lithium secondary battery with improved electrochemical properties such as a specific capacity, a capacity retention rate, and coulombic efficiency.

The effect of the present disclosure is not limited to the above-described effects. It should be understood that the effects of the present disclosure include all effects inferable from the following description.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The above and other features of the present disclosure are discussed infra.

### BRIEF DESCRIPTION OF THE DRAWINGS

FIG. 1 shows perspective view exemplarily illustrating a pouch-type lithium secondary battery according to an exemplary embodiment of the present disclosure;

FIG. 2 shows cross-sectional view exemplarily illustrating the pouch-type lithium secondary battery according to an exemplary embodiment of the present disclosure;

FIG. 3 shows an electrode assembly according to various exemplary embodiments of the present disclosure;

FIG. 4 shows an electrode assembly according to various exemplary embodiments of the present disclosure;

FIG. 5 shows an electrode according to an exemplary embodiment of the present disclosure;

FIG. 6 shows a surface pattern of the electrode according to an exemplary embodiment of the present disclosure;

FIG. 7 shows a surface of a cathode according to Preparation Example analyzed by a field emission scanning electron microscope (FE-SEM);

FIG. 8 shows a height difference in color as a result of the same region as in FIG. 7;

FIG. 9 shows the surface of the cathode according to Preparation Example analyzed by a scanning electron microscope (SEM);

FIG. 10 shows discharge capacities of the pouch-type lithium secondary batteries according to Example and Comparative Examples 1 and 2;

FIG. 11 shows capacity retention rates of the pouch-type lithium secondary batteries according to Example and Comparative Examples 1 and 2; and

FIG. 12 shows coulombic efficiencies of the pouch-type lithium secondary batteries according to Example and Comparative Examples 1 and 2.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The above objects, other objects, features, and advantages of the present disclosure will be easily understood through the following exemplary embodiments in conjunction with the accompanying drawings. However, the present disclosure is not limited to the exemplary embodiments described herein and may also be predetermined in other forms. Rather, the exemplary embodiments introduced herein are provided so that the disclosed contents may be thorough and complete and the spirit of the present disclosure may be sufficiently conveyed to those skilled in the art.

Like reference numerals have been used for like components throughout the description of each drawing. In the accompanying drawings, the dimensions of the structures are illustrated enlarged than the actual sizes for clarity of the present disclosure. Terms such as first and second may be used to describe various components, but the components should not be limited by the terms.

In the specification, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof. Furthermore, when a part such as a layer, a film, a region, or a plate is described as being “on” another part, this includes not only a case in which the part is “directly on” another part, but also a case in which other parts are present therebetween. Conversely, when a part such as a layer, a film, a region, or a plate is described as being “under” another part, this includes not only a case in which the part is “directly under” another part, but also a case in which other parts are present therebetween.

Unless otherwise specified, since all numbers, values, and/or expressions expressing quantities of components, reaction conditions, polymer compositions, and formulations used herein are approximations that reflect various uncertainties of the measurement fundamentally caused when such numbers are obtained among other things, it should be understood that they are described by the term “about” in all cases. Furthermore, when a numerical range is disclosed herein, the range is contiguous and includes all values from the minimum value to the maximum value in the range, unless otherwise indicated. Furthermore, when the range is an integer, the range includes all integers from the minimum value to the maximum value, unless otherwise indicated.

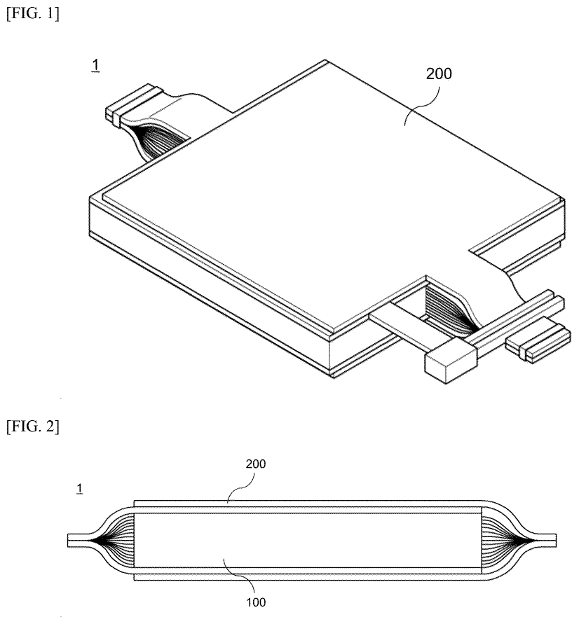

FIG. 1 shows perspective view exemplarily illustrating a pouch-type lithium secondary battery 1 according to an exemplary embodiment of the present disclosure. FIG. 2 shows cross-sectional view exemplarily illustrating the pouch-type lithium secondary battery 1 according to an exemplary embodiment of the present disclosure. Referring to FIG. 1 and FIG. 2, the pouch-type lithium secondary battery 1 may include an electrode assembly 100 and a case 200 for accommodating the electrode assembly 100.

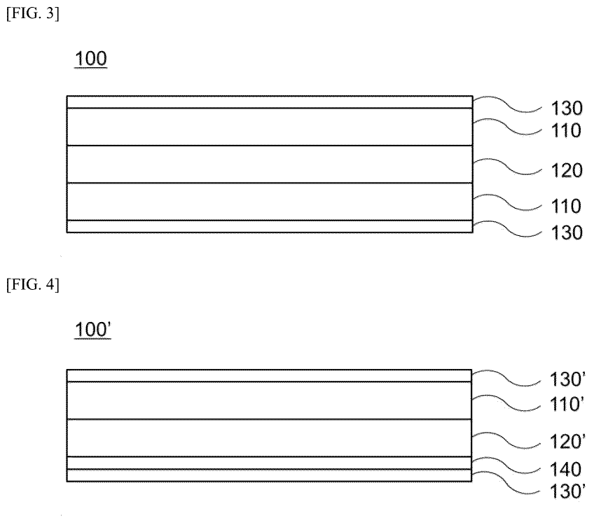

FIG. 3 shows the electrode assembly 100 according to a first exemplary embodiment of the present disclosure. The electrode assembly 100 may include a pair of electrodes 110 having different polarities, a solid electrolyte layer 120 located between the electrodes 110, and a pair of current collectors 130 positioned on an outermost portion thereof.

FIG. 4 shows an electrode assembly 100′ according to a second exemplary embodiment of the present disclosure. The electrode assembly 100′ according to the second exemplary embodiment may be an anodeless battery. The anodeless battery may be a battery excluding an anode active material and a component having substantially the same role as the anode active material. The electrode assembly 100′ may include a solid electrolyte layer 120′ located between an anode current collector 130′ including a coating layer 140 and an electrode 110′.

The coating layer 140 may include a metal capable of forming an alloy with amorphous carbon and lithium.

The amorphous carbon may include at least any one selected from the group consisting of furnace black, acetylene black, ketjen black, graphene, and combinations thereof.

The metal may include at least any one selected from the group consisting of gold (Au), platinum (Pt), palladium (Pd), silicon (Si), silver (Ag), aluminum (Al), bismuth (Bi), tin (Sn), zinc (Zn), and combinations thereof.

In the electrode assembly 100′, upon charging, lithium ions discharged from the electrode 110 may be deposited and stored in the form of lithium metal between the coating layer 140 and the current collector 130″.

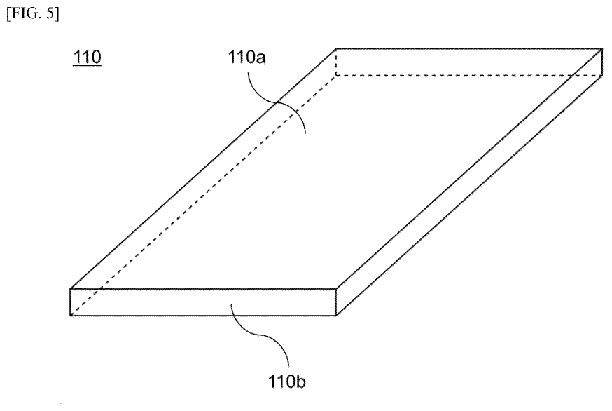

FIG. 5 shows the electrode 110 according to an exemplary embodiment of the present disclosure. The electrode 110 may have a sheet shape including a first main surface 110a and a second main surface 110b facing the first main surface 110a. Each of the first main surface 110a and the second main surface 110b may include not only a planar surface but also partially a constant curved surface and also have unevenness formed when the electrode 110 is manufactured. In the present sense, the sheet shape is not limited to a relatively thin cuboid.

The electrode 110 may be manufactured by a dry method. A dry manufacturing method of the electrode 110 is not specially limited. For example, the manufacturing method may include an operation of obtaining a start material by mixing electrode materials such as an active material, a solid electrolyte, a conductive material, and a binder by a dry method, a film forming operation of applying shear stress to the start material, etc. When the shear stress is applied to the start material, the binder is fiberized, and an adhesion strength may be provided to the remaining electrode materials.

The binder capable of fiberization is not specially limited. For example, the binder may include polytetrafluoroethylene (PTFE).

The polytetrafluoroethylene (PTFE) is a polymer in which all hydrogen elements of polyethylene (PE) are substituted with fluorine elements. Although the polytetrafluoroethylene (PTFE) is a polymer having an aliphatic main chain, the polytetrafluoroethylene (PTFE) has excellent thermal stability and electrical stability and thus is widely applied in the field of electronic materials. The polytetrafluoroethylene (PTFE) is mainly used for a cathode because a highest occupied molecular orbital (HOMO) level of the polymer is low and thus oxidation stability is high. Because the polytetrafluoroethylene (PTFE) has a cylinder-shaped structure, fiberization is possible even at a low temperature even though the polytetrafluoroethylene (PTFE) has a high glass transition temperature (Tg).

A method of applying the shear stress is not specially limited. For example, the shear stress may be applied to the start material by feeding the start material between a pair of rollers. At the instant time, when the shear stress applied to the start material is not sufficient, the pair of rollers may not press the start material at a constant thickness, and thus a difference in forces applied to each part of the electrode 110 may occur. Therefore, because the surface of the electrode 110 obtained through the film forming operation is rough, mechanical properties such as a tensile strength may be degraded.

The present disclosure provides a pouch-type lithium secondary battery with improved electrochemical properties by applying sufficient shear stress to the start material to make the thickness of the electrode 110 uniform and adjusting the width, the area, and the like of the surface pattern formed in the film forming operation.

A strength of the shear stress applied to the start material may be appropriately adjusted according to a target width and thickness of the electrode 110, the type of the electrode material, and the like, and when conditions in which the electrode 110 needs to be satisfied, which will be described below, may be achieved, the present disclosure is not greatly limited thereto. The method of adjusting the strength of the shear stress is not specially limited, and when the pair of rollers are used, the strength of the shear stress may be adjusted by changing a distance between the rolls, a speed ratio between the rolls, etc.

The electrode 110 may have a thickness A, and an average thickness B of the thickness A at any one point on the first main surface 110a that satisfy Expression 1 below.

$$\vert A - B \vert \leq 0.1 \cdot B \qquad [ Expression 1 ]$$

Here, the thickness A may be a distance between the first main surface 110a and the second main surface 110b. The thickness may be measured by use of thickness measuring equipment commonly used in the art to which the present disclosure pertains. The average thickness B may be a value obtained by measuring thicknesses of 10 or more portions using the thickness measuring equipment and averaging the thicknesses.

Because the surface roughness of the electrode 110 is low when Expression 1 is satisfied, a uniform interface with the solid electrolyte layer 120 and the current collector 130 may be formed. According to an exemplary embodiment of the present disclosure, because an interfacial resistance of the electrode 110 is reduced, it is possible to improve the electrochemical properties of the pouch-type lithium secondary battery 1.

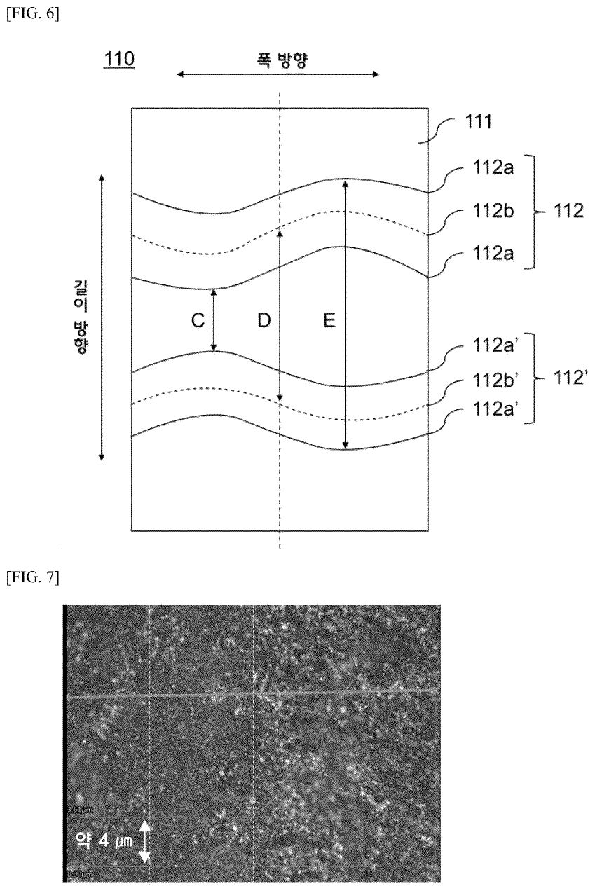

When the electrode 110 is formed by the dry manufacturing method, a kind of pattern may be formed on the surface as shown in FIG. 6. Referring to FIG. 6, the electrode 110 may include a flat part 111 and a plurality of pattern parts 112 protruding with a predetermined width in a width direction of the electrode 110.

The flat part 111 may be a portion having a thickness equal to or smaller than the average thickness of the electrode 110.

The plurality of pattern parts 112 may be positioned to be spaced at a predetermined distance from each other in a longitudinal direction of the electrode. The pattern part 112 may include a boundary line 112a dividing the pattern part 112 from the flat part 111 and a center line 112b connecting center points of a distance between the boundary lines 112a.

The electrode 110 may satisfy Expressions 2 and 3 below.

$$C < 0.6 \cdot D \qquad [ Expression 2 ]$$

$$1.3 \cdot D < E \qquad [ Expression 3 ]$$

In Expression 2, C may be the shortest distance between any one pattern part 112 and another pattern part 112′ adjacent to the pattern part 112 in the longitudinal direction of the electrode.

In Expressions 2 and 3, D may be a distance between the center line 112b of any one pattern part 112 and the center line 112b′ of another pattern part 112′ adjacent to the pattern part 112 based on the center portion of the electrode 110 in the longitudinal direction of the electrode.

In Expression 3, E may be the longest distance between any one pattern part 112 and another pattern part 112′ adjacent to the pattern part 112 in the longitudinal direction of the electrode.

The distances denoted by C, D, and E may be straight-line distances in a longitudinal direction of the electrode 110.

Based on the center portion of the electrode 110, a distance between the center line 112b′ of any one pattern part 112 and the center line 112b′ of another pattern portion 112′ adjacent thereto in the longitudinal direction of the electrode may be 150 μm or less. A lower limit of the distance between the center lines 112b and 112b′ is not specially limited, and may be, for example, 10 μm or more, 30 μm or more, 50 μm or more, or 100 μm or more.

When the electrode 110 satisfies Expressions 2 and 3, it is possible to increase a capacity of the pouch-type lithium secondary battery 1.

The electrode 110 may satisfy Expression 4 below.

$$3 \leq F / G \qquad [ Expression 4 ]$$

In Expression 4, F may be an area of the flat part 111.

G may be an area of the pattern part 112 among the plurality of the pattern parts.

When the electrode 110 satisfies Expression 4, it is possible to increase the capacity of the pouch-type lithium secondary battery 1.

Hereinafter, other forms of the present disclosure will be described in more detail through the examples. The following examples are merely examples to help understanding of the present disclosure, and the scope of the present disclosure is not limited thereto.

### Preparation Example

A start material was obtained by mixing a cathode active material, a sulfide-based solid electrolyte, a conductive material, and a binder by a dry method. A semi-finished product was obtained by putting the start material between a pair of rollers provided in film forming equipment to form a film. The film forming equipment was a two-roll rolling mill (Intec System Co.). The two-roll rolling mill automatically measures and records a change value of a distance between the rollers and a pressure of the roller while forming the start material into a film. A gap between the pair of rollers was about 0.06 mm, and a speed ratio between the rollers was 1:10 (front roller speed:rear roller speed). Shear stress was applied to the start material by varying the speed ratio between the rollers. A cathode was obtained by cutting the semi-finished product to a width of 30 mm and a length of 40 mm.

FIG. 7 shows a cathode according to Preparation Example analyzed by a field emission scanning electron microscope (FE-SEM). A profile of the thickness along an upper line in FIG. 7 is illustrated at a lower side. It may be seen that a thickness difference between the flat part and the pattern part is about 4 μm.

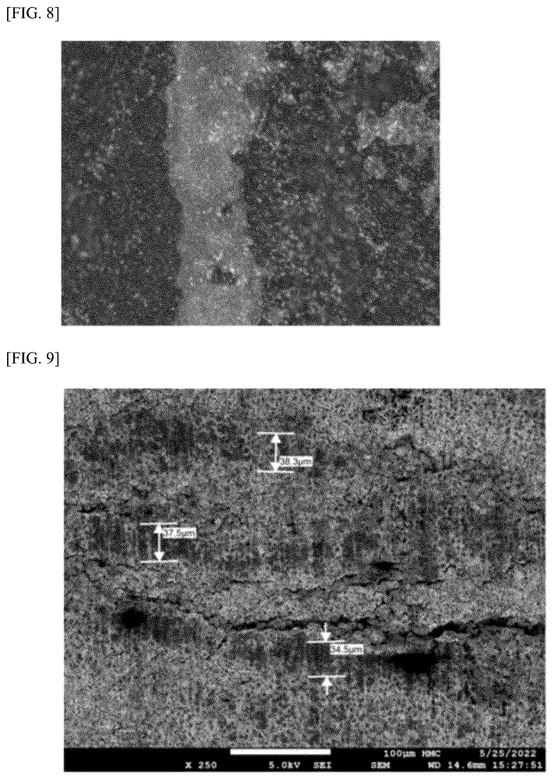

FIG. 8 shows a height difference as a result of the same region as in FIG. 7. As in FIG. 7, it may be confirmed that there is also a thickness difference in FIG. 8.

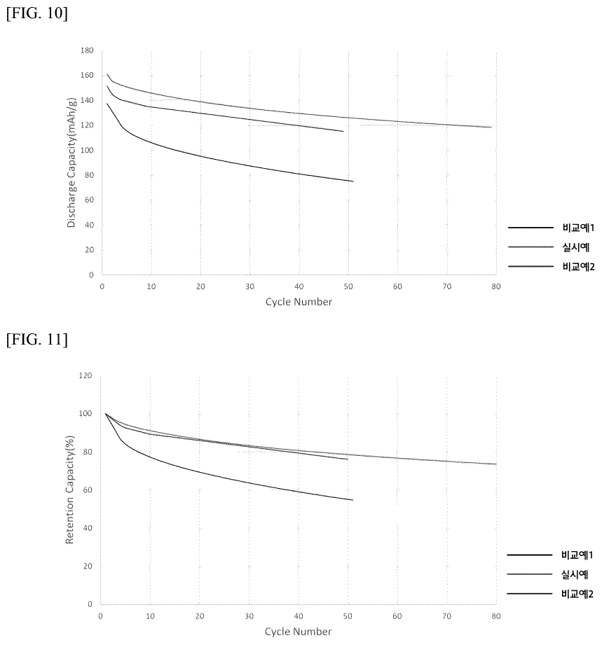

FIG. 9 shows the surface of the cathode according to Preparation Example analyzed by a scanning electron microscope (SEM). Referring to FIG. 9, it may be seen that a pattern part was formed on the surface of the electrode at a width of about 30 μm to 40 μm.

### Comparative Preparation Example 1 (Surface Control X)

A cathode was manufactured in the same manner as in Preparation Example, except that the gap between the pair of rollers was adjusted to about 0.08 mm and the speed ratio between the rollers was changed to 1:12.

### Comparative Preparation Example 2 (Surface Control Δ)

A cathode was manufactured in the same manner as in Preparation Example, except that the gap between the pair of rollers was adjusted to about 0.08 mm.

Specifications of the cathode according to Preparation Example, Comparative Preparation Example 1 and Comparative Preparation Example 2 were measured and expressed in Table 1 below.

TABLE 1

| | Compar- | | Compar- |
|---|---|---|---|
| | ative | | ative |
| | Prepara- | Prepara- | Prepara- |
| | tion | tion | tion |
| Items | Example 1 | Example | Example 2 |
| Thickness A at any one point | 123 | 95 | 107 |
| Average thickness B | 100 | 90 | 94 |
| Whether Expression 1 is satisfied | x | ◯ | X |
| Shortest distance C between any | 85 | 80 | 77 |
| one pattern part and another pattern | | | |
| part adjacent thereto | | | |
| Distance D between center line of | 135 | 140 | 132 |
| any one pattern part and center line | | | |
| of another pattern part adjacent | | | |
| thereto | | | |
| Longest distance E between any | 160 | 190 | 173 |
| one pattern part and another pattern | | | |
| part adjacent thereto | | | |
| Whether Expression 2 is satisfied | ◯ | ◯ | ◯ |
| Area F of flat part | 70 | 75 | 80 |
| Area G of pattern part | 30 | 25 | 20 |
| Whether Expression 4 is satisfied | X | ◯ | ◯ |

Referring to Table 1, it may be seen that the cathode according to Preparation Example satisfies Equations 1 to 4, whereas Comparative Preparation Example 1 does not satisfy Equations 1, 3, and 4, and Comparative Preparation Example 2 does not satisfy Equation 1.

### EXAMPLE

An electrode assembly was manufactured by stacking an anode current collector, a coating layer, a solid electrolyte layer, and the cathode and the cathode current collector according to Preparation Example. The coating layer includes amorphous carbon and silver (Ag) powder.

A pouch-type lithium secondary battery was obtained by storing the electrode assembly in a case.

### Comparative Example 1

A pouch-type lithium secondary battery was manufactured in the same manner as in Example, except that the cathode according to Comparative Preparation Example 1 was used.

### Comparative Example 2

A pouch-type lithium secondary battery was manufactured in the same manner as in Example, except that the cathode according to Comparative Preparation Example 2 was used.

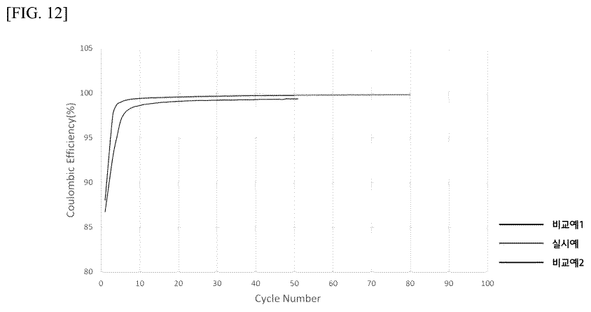

FIG. 10 shows discharge capacities of the pouch-type lithium secondary batteries according to Example and Comparative Examples 1 and 2. FIG. 11 shows capacity retention rates of the pouch-type lithium secondary batteries according to Example and Comparative Examples 1 and 2. FIG. 12 shows coulombic efficiencies of the pouch-type lithium secondary batteries according to Example and Comparative Examples 1 and 2. Referring to FIG. 10, FIG. 11, and FIG. 12, it may be seen that the discharge capacity, the capacity retention rate, and the coulombic efficiency of the pouch-type lithium secondary battery according to the exemplary embodiment in which the surface roughness and the specification of the pattern part are adjusted are higher than those of Comparative Examples 1 and 2.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electrode for a lithium secondary battery,
wherein the electrode has a sheet shape comprising a first main surface and a second main surface facing the first main surface,
wherein a thickness (A) at any one point on the first main surface and an average thickness (B) of the thickness (A) at the any one point on the first main surface satisfy Expression 1 below,
$$\vert A - B \vert \leq 0.1 \cdot B . \qquad [ Expression 1 ]$$

2. The electrode for the lithium secondary battery of claim 1, comprising:
a flat part; and
a plurality of pattern parts protruding with a predetermined width in a width direction of the electrode,
wherein the plurality of pattern parts is spaced apart from each other at a predetermined distance in a longitudinal direction of the electrode.

3. The electrode for the lithium secondary battery of claim 2, which satisfies Expression 2 below,
$$C < 0.6 \cdot D \qquad [ Expression 2 ]$$
wherein C is a shortest distance between any one pattern part and another pattern part adjacent thereto in the longitudinal direction of the electrode, and
wherein D is a distance between a center line of any one pattern part and a center line of another pattern part adjacent thereto based on a center portion of a width of the electrode in the longitudinal direction of the electrode.

4. The electrode for the lithium secondary battery of claim 2, which satisfies Expression 3 below,
$$1.3 \cdot D < E \qquad [ Expression 3 ]$$
wherein D is a distance between a center line of any one pattern part and a center line of another pattern part adjacent thereto based on a center portion of a width of the electrode in the longitudinal direction of the electrode, and
wherein E is a longest distance between any one pattern part and another pattern part adjacent thereto in the longitudinal direction of the electrode.

5. The electrode for the lithium secondary battery of claim 2, wherein a distance between a center line of any one pattern part and a center line of another pattern part adjacent thereto in the longitudinal direction of the electrode is 150 μm or less.

6. The electrode for the lithium secondary battery of claim 2, which satisfies Expression 4 below,
$$3 \leq F / G \qquad [ Expression 4 ]$$
wherein F is an area of the flat part, and
wherein G is an area of a pattern part among the plurality of the pattern parts.

7. A pouch-type lithium secondary battery comprising:
an electrode assembly; and
a case configured to store the electrode assembly,
wherein the electrode assembly comprises the electrode of claim 1.
